(19) United States
(12) Patent Application Publication
(10) Pub. No.: US 2009/0105620 A1
(43) Pub. Date: Apr. 23, 2009

(54) Soft-power concentrating hand massage device and method

(76) Inventors: Katherine Wolfe, Portland, OR (US); Susan A. Baer, Portland, OR (US)

Correspondence Address: ATER WYNNE LLP, 1331 NW Lovejoy St. Suite 900, PORTLAND, OR, 97209-2785, US

(21) Appl. No.: 11/977,389

(22) Filed: Oct. 23, 2007

(51) Int. Cl. A61H 7/00

(52) U.S. Cl. 601/135

(57) ABSTRACT

A convex, generally cone-shaped working surface and a generally planar base configured to fit comfortably in a user's hand is described. The device is configured to be shape-retentive by its elastic composition such that it momentarily deforms slightly under pressure but returns in the absence of pressure to its original generally cone shape. The device in one configuration has a single apex region or working surface. The device in another configuration has two spaced apart apex regions or working surfaces. The device can be integrally molded from one or more materials chosen from a group consisting of silicone, polyurethane, neoprene, or the like. A method of using the device also is described.

### FIELD OF THE INVENTION

The invention relates generally to the field of body massage. More particularly, the invention relates to a device and method used to manually assist the body massage process.

### BACKGROUND OF THE INVENTION

Known active massage assistance devices include powered vibratory devices having so-called Shiatsu rollers. Known passive massage assistance devices include hard passive roller balls on a end of a handle and devices without moving parts that present plural, convexly curved, spaced, hard knobs for contact with the massage subject's skin. U.S. Pat. No. 7,156,817 B1 entitled MASSAGE BALL describes and illustrates a spherical, multi-layered massage ball that purportedly simulates the hardness and deformation characteristics of the human thumb, but which is approximately the size of a person's clenched first. The massage ball has a hard, solid core having wrapped therearound plural alternate layer pairs of elastic and compressive materials, all covered by a rigid plastic cover.

### BRIEF DESCRIPTION OF THE DRAWINGS

FIG. 1 is a front elevation of the invented massage device in accordance with one embodiment of the invention featuring a single conic shape and a rounded apex.

FIG. 2 is a top plan view corresponding with FIG. 1.

FIG. 3 is an isometric view of the invented massage device of FIG. 1.

FIG. 4 is a front elevation of the invented massage device in accordance with a second embodiment of the invention having a concave or convex base and an optional handle or strap.

FIG. 5 is a top plan view corresponding with FIG. 4.

FIG. 6 is a front elevation of the invented massage device in accordance with a third embodiment of the invention having a double apex.

FIG. 7 is a top plan view corresponding with FIG. 6.

FIG. 8 is an isometric view of the invented massage device in accordance with a third embodiment of the invention having the double apex.

FIGS. 9A-9C schematically illustrate force vectors under relative levels of pressure.

### DETAILED DESCRIPTION OF THE PREFERRED EMBODIMENTS

The invented device includes a convex, generally cone-shaped working surface and a generally planar base configured to fit comfortably in a user's hand. The device is configured to be shape-retentive by its elastic composition such that it momentarily deforms slightly under pressure but returns in the absence of pressure to its original generally cone shape. The cone shape concentrates what will be referred to herein as “soft power” from the user's hand to the subject's body, enabling deep tissue and muscle massage thereof with minimum effort on the part of the user. By virtue of the generally cone-shaped working surface, different parts of the working surface can be brought to bear by the user adjusting the angle of incidence between the cone's central axis and the subject's body. Thus, the soft power that is concentrated by the invented massage device is adjustable by the user to vary the depth and breadth of tissue and muscle “penetration.”

The diameter of the human thumb from ring size gauges has been determined to range from approximately 19-24 millimeters (mm), with the mean diameter being approximately 21-22 mm. From an anatomical point of view, then, the invented device in accordance with one embodiment of the invention is dimensioned to simulate not only the pressure imparted by the human thumb, but also (in its apex region) the shape or configuration and the dimension of the human thumb. Those of skill in the art will appreciate that other configurations and dimensions would produce similar simulations of the pressure of the human thumb on a person's tissue or muscles or facie, and so alternative configurations and dimensions are contemplated as being within the spirit and scope of the invention described in detail below.

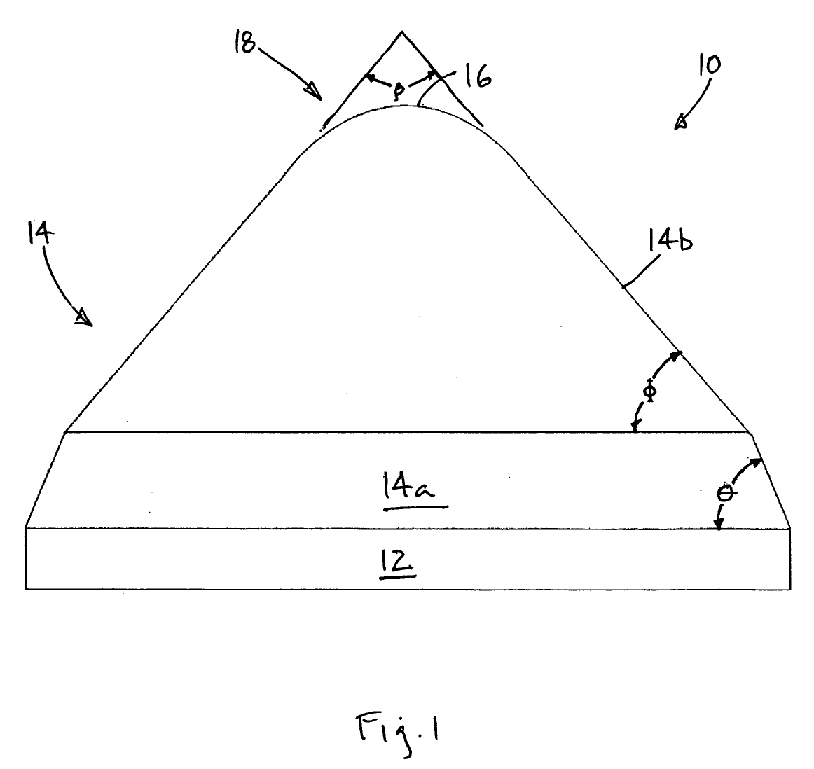

FIG. 1 is a front elevation of the invented massage device 10 in accordance with one embodiment of the invention. Device 10 includes a planar base region or base 12, an intermediate, piece-wise linear contour region 14, and a tip or apex region 16. Those of skill in the art will appreciate that base region 12 is generally right cylindrical, and is of sufficient height to provide purchase and comfort when it is gripped within the palm of a user, e.g. between the thenar eminence muscle group near the base of the thumb and the hypo-thenar eminence muscle group near the base of the little finger opposite the thumb. Piece-wise linear contour region 14 in accordance with one embodiment of the invention includes a relatively short, lower region 14a adjacent base 12 and a relatively tall, upper region 14b adjacent apex region 16. In accordance with one embodiment of the invention, lower region 14a inclines upwardly inwardly at an angle θ of approximately 70° relative to the horizontal. Also in accordance with one embodiment of the invention, upper region 14b inclines upwardly inwardly at an angle Φ of approximately 50° relative to the horizontal. This latter angle creates a so-called conic taper or internal angle β relative to the cone's apex of approximately 80°. Finally in accordance with one embodiment of the invention, apex region 16 is rounded as shown, and smoothly joins the upper extent of upper piece-wise linear region 14b.

These angular features give device 10 a generally cone shape, but with a faceted appearance, a rounded apex, and a columnar base. In accordance with one embodiment of the invention, device 10 is unitarily molded from any suitably shape-retentive and deformable material such as silicone, polyurethane, neoprene, or the like. Those of skill in the art will appreciate that the material is chosen for its durability and softness, and that the so-called working surface 18 of device 10 is smooth but not slippery when applied, even forcefully, to a subject's skin.

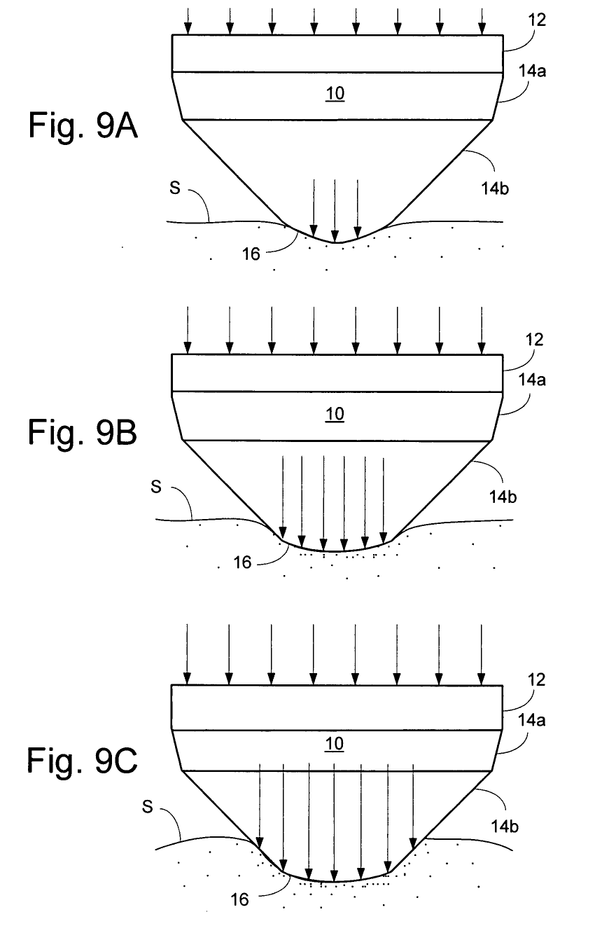

The deformation that device 10 undergoes during its normal use is controlled by the unique structure and material combination described and illustrated herein. This will be described in more detail below by reference to FIGS. 9A-9C. Those of skill in the art will appreciate that such deformation is only temporary, as device 10 returns to and retains its normal shape when the deformation force or pressure is removed.

In accordance with one embodiment of the invention, device 10 is approximately 58.2 mm (1.99″) high, base 12 of device 10 is approximately 80 mm (3.13″) in diameter, and rounded apex region 16 is approximately 21.4 mm (0.84″) wide. Also in accordance with one embodiment of the invention, base 12 is approximately 5.5 mm (0.22″) high; lower region 14a is approximately 9.9 mm (0.39″) high; upper region 14b is approximately 30 mm (1.18″) high; and rounded apex region 16 is approximately 5.2 mm (0.2″) high.

These dimensions are for illustrative purposes only and are not intended to limit the invention in any way. For example, base 12 can be of less height, depending upon the desired fit and grip-ability with the user's palm. Other heights, widths and ratios can be adjusted as well. Thus, those of skill in the art will appreciate that invented device 10 can be suitably dimensioned in alternative ways, all of which are contemplated as being within the spirit and scope of the invention.

Those of skill in the art will appreciate that the device's height to width ratio (H:W) in accordance with one embodiment of the invention thus is between approximately 0.055 and 0.75 and more definitely approximately 0.64. This H:W ratio is believed to impart to invented device 10 the structural and material integrity that renders it easily gripped, guided and pressed into tissue, muscle and facie of the subject during a massage. The overall generally tapered or conic configuration of the device will be understood to concentrate so-called “soft power” from the user's hand pressure to a target such as a trigger point being impacted by the apex. Such power leverage is nevertheless controlled, e.g. governed or limited, by the material and structure, as will be seen below by reference to FIGS. 9A-9C, thereby avoiding potential discomfort or even injury to the massage subject.

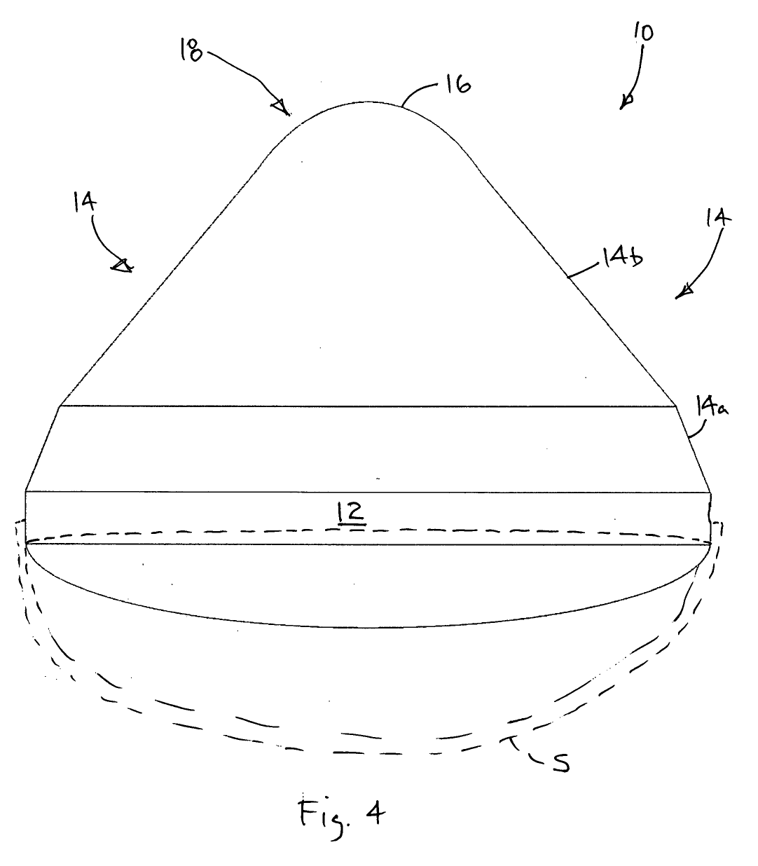

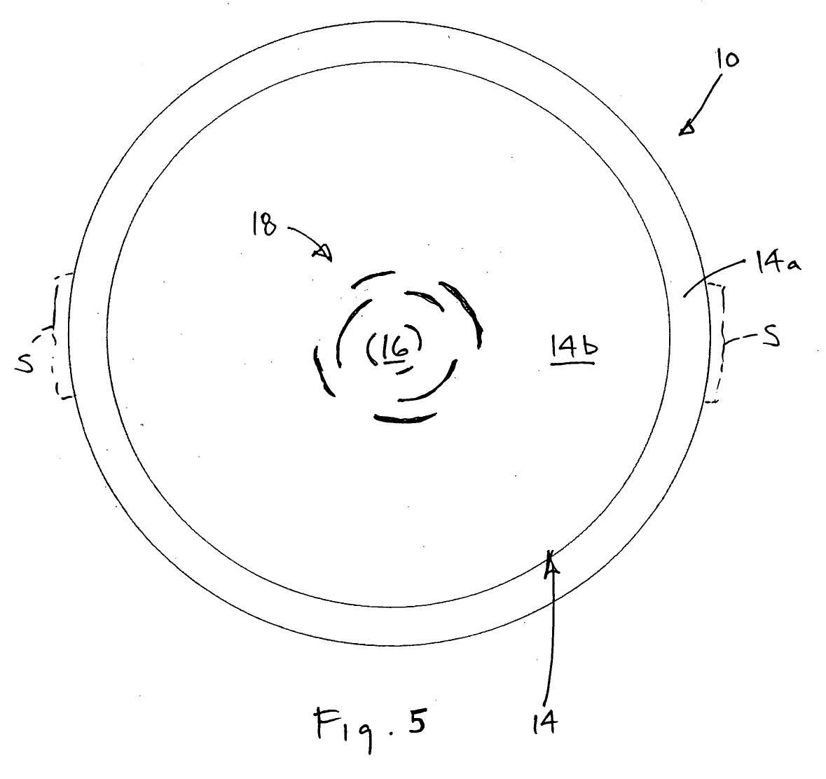

Those of skill in the art will appreciate from the solid and dashed lines of FIGS. 1, 4 and 6 that base 12 can be planar, slightly concave, or slightly convex. A slight concavity in the bottom surface of the base makes it into a suction cup that enables device 10 to be conveniently attached on a mirror, shower door, cabinet door, smooth wall, ceiling, or the like. The concavity thus facilitates self-massage as will be described below. Alternatively, base 12 can be less slightly convex, thereby better to conform with the curved interior of a user's palm for more surface contact area when gripping it. These and other base configuration alternatives are contemplated as being within the spirit and scope of the invention. Base 12 optionally can include a strap or handle, as will be seen by reference below to FIGS. 4 and 5.

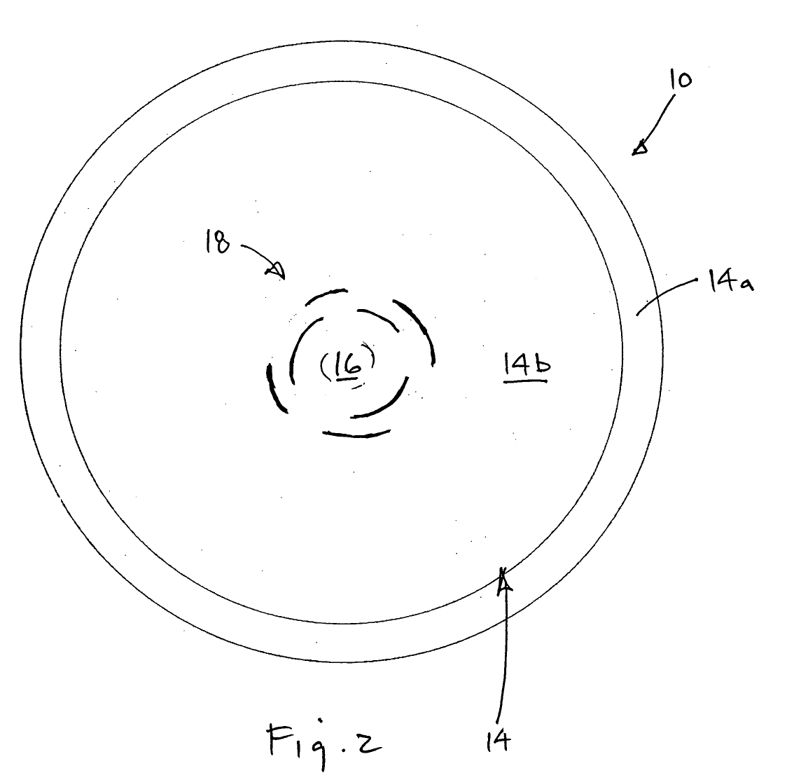

FIG. 2 is a top plan view corresponding with FIG. 1. FIG. 2 shows the circular symmetric configuration of device 10 that renders it useful for massage regardless how it is picked up, i.e. irrespective of its circular rotation or orientation in the hand. Those of skill in the art will appreciate that a bottom view of the device is identical but for the interior circular line.

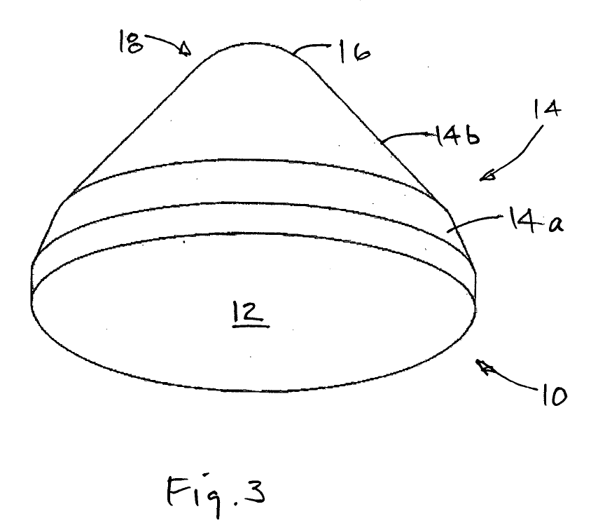

FIG. 3 is an isometric view of the invented massage device of FIG. 1. FIG. 3 shows the overall configuration and shape of device 10 as being generally cone shaped with a circular cross section and a rounded apex.

In accordance with one embodiment of the invention, the silicone material from which device 10 is molded has a Shore hardness (on the A scale) of between approximately 25 and 45, i.e. 35±10, and more specifically between approximately 30 and 40, i.e. 35±5. This range of durometer ratings has been determined experimentally to strike an effective tradeoff between durability and deformability to device 10 while properly concentrating power toward apex region 16 thereof from base 12 thereof. Those of skill in the art will appreciate that this durometer rating also has been determined to permit a user to deliver sufficient power to the apex region effectively to increase the weight bearing on the subject's tissue and muscle.

Many massage therapists use the point of the elbow to achieve deep massage. The maximum weight that typically can be brought to bear with an elbow is approximately 55 lbs. Use of the invented device brings to bear appreciably more, approximately 95 lbs. This is because the invented device is held centrally, and the entire weight of the user's torso can come down through the guiding and gripping hands and onto the base and through the body to the apex region of the invented device. Moreover, the invented device is softer and thus more comfortable than an elbow, which has very little tissue covering hard bone.

FIGS. 4 and 5 respectively are a front elevation and a top plan view of the invented massage device in accordance with a second embodiment of the invention wherein base 12′ optionally is convex (solid lines) or concave (dashed lines) and wherein base 12′ optionally is equipped with a handle or strap S also indicated by dashed lines. Those of skill in the art will appreciate that, in other respects, the second embodiment of the invention is identical with the first embodiment, and that, except for curvature of the base, the isometric view is also identical. Those of skill also will appreciate that a bottom view of the device would be identical with the top view but for the interior circular line.

In accordance with the illustrated second embodiment of the invention, the convexity at the center of the base is approximately 1.1 mm (0.04″), and the degree of concavity at the center of the base is approximately 8.5 mm (0.34″), although such degrees of convexity and concavity are illustrative only and do not represent a limitation of the invention. Thus, in accordance with this embodiment of the invention, the degrees of base convexity and concavity are differential as their purpose is different—the concavity is intended to create a vacuum when applied to a flat surface for better adhesion when not in use in the user's hand whereas the convexity is intended to create a palm-fitting handle for better gripping when in use. Those of skill in the art also will appreciate that the degree of convexity or concavity of the base, within the spirit and scope of the invention, can be different from those shown, yet be within the spirit and scope of the invention.

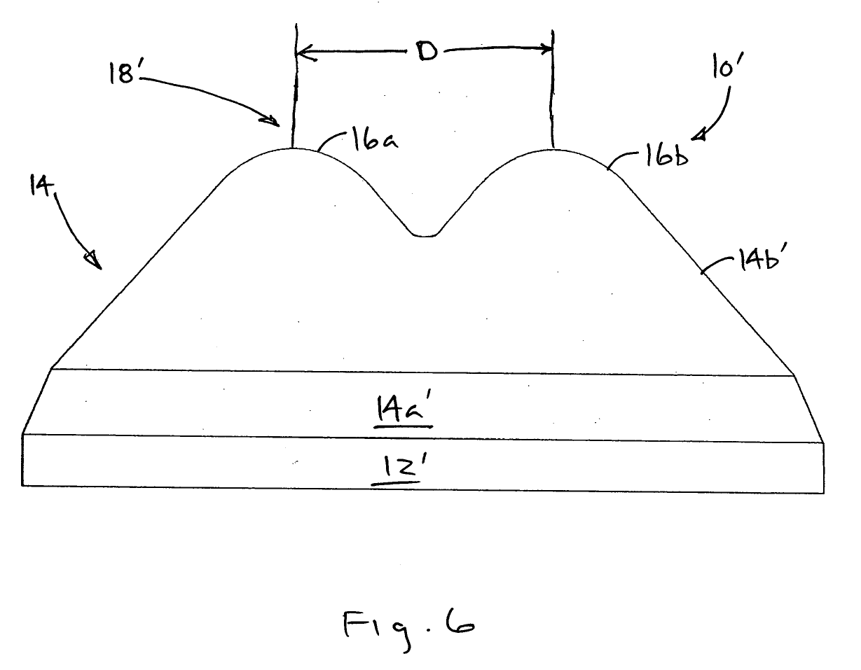

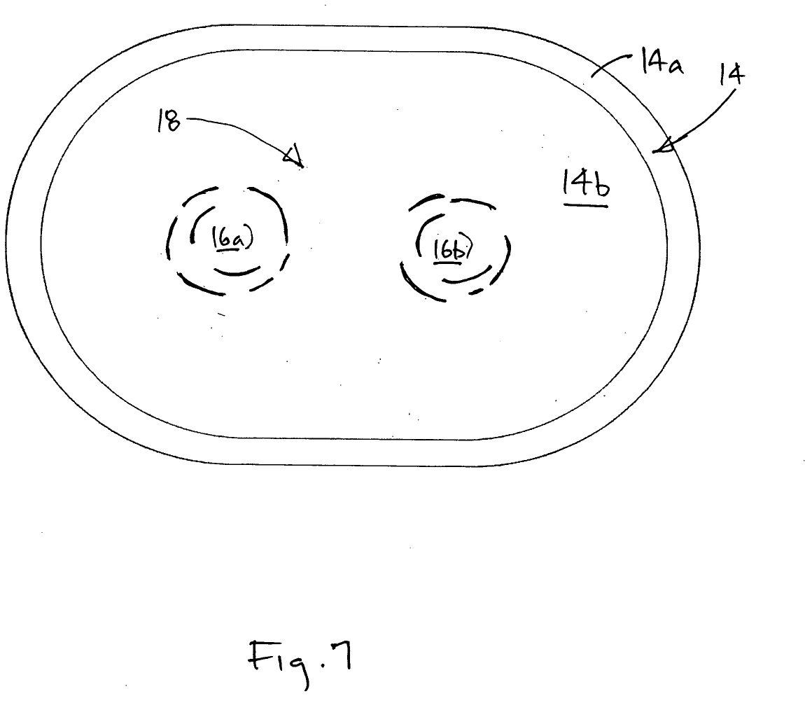

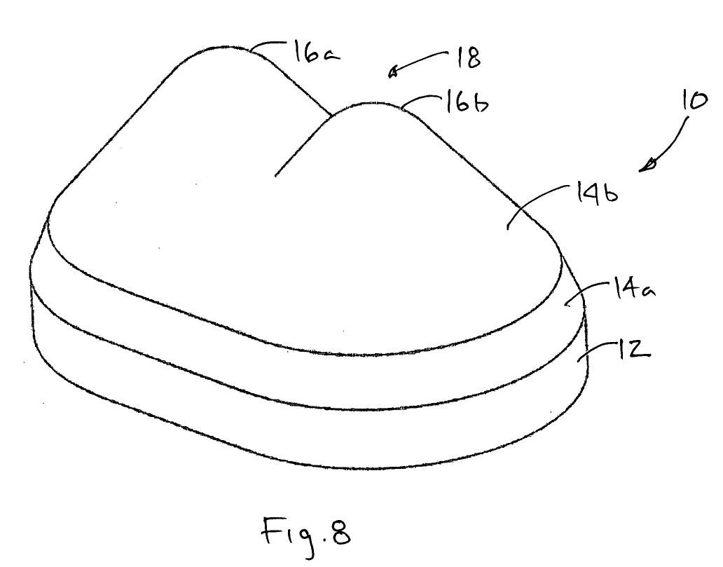

FIGS. 6, 7, and 8 respectively are a front elevation, a top plan view, and an isometric view of the invented massage device in accordance with a third embodiment of the invention in which working surface 18′ of device 10′ includes not one but two spaced-apart apex regions 16a and 16b. From FIG. 6 it will be appreciated that apex regions 16a and 16b are spaced apart from one another (center-to-center) a distance D along base 12′ approximately 76 mm (3″), although a different spacing is within the spirit and scope of the invention. FIG. 7 shows the oval or broadly rounded rectangular shape of invented device 10′ in what may be seen effectively to squish two devices 10 together at a defined center-to-center spacing of their respective apex regions 16a and 16b. While the outline could be a figure-8 or hourglass or dumbbell shape, it is believed that the oval or broadly rounded rectangular shape of the base renders it more durable against undesirable torque around its midpoint and more hand-grip friendly, i.e. easier to grip. Those of skill in the art will appreciate, nevertheless, that any suitable base shape is contemplated as being within the spirit and scope of the invention in accordance with this third embodiment broadly disclosed and claimed herein. FIG. 8 shows the overall configuration and surface contours of the invented massage device of FIG. 6. Those of skill in the art will appreciate that a bottom view would be identical to the top plan view but for the interior oval line.

Those of skill in the art will appreciate that this embodiment of the invention lends itself to spinal adjustment as well as massage. Those of skill in the art will appreciate that a double-apex embodiment of the invention is useful especially for chiropractors in adjusting and/or massaging a subject's spine using a technique referred to as ‘stripping’, i.e. running it up and down the back (typically with lotion). In this embodiment, device 10′ includes a base and two apex regions spaced apart the distance D of approximately 76 mm (3″) on center, because that is the approximate distance between the sides of the back muscle group, the erector spinae, that runs up either side of the spine. Those of skill in the art will appreciate that, within the spirit and scope of the invention, more apex regions can be included in the device and/or their spacing can be greater than or less than the spacing described and illustrated herein.

FIGS. 9A, 9B, and 9C schematically illustrate using straightforward force vector diagrams how apex region 16 of invented device 10 deforms when pressed against a subject's skin. As may be seen from FIG. 9A, when slight pressure is used against base 12 of device 10, greater pressure due to concentration is exerted to a relatively small, targeted area by apex region 16. As may be seen from FIG. 9B, when more pressure is used against base 12 of device 10, greater pressure due to concentration is exerted but over a relatively larger, target area by apex region 16. This phenomenon is due to force distribution over the larger area of the apex region that is flattened from the greater pressure. Thus, the pressure impacting on the subject's tissue is self-governing to some extent due to the deformation characteristics of the material and structure of device 10. As may be seen from FIG. 9C, when even more pressure is used against base 12 of device 10, even greater pressure due to concentration is exerted but over the same, relatively larger area of the apex region. This is because the apex region only flattens so much, and then tends to flatten little or no farther, due to the material and structural makeup of device 10. This enables the user of device 10 by varying the pressure applied to the base to access deep trigger points or shallower regions, as needed by the subject.

The invented device in its many embodiments described and illustrated herein can be made of any suitably shape-retentive and deformable material. In accordance with one embodiment of the invention, silicone is used because it is non-reactive, resistant to oil and alcohol, and can be frozen or boiled without material or structural damage to the device. Those of skill in the art will appreciate that silicone is soft, meaning that it deforms to a controlled extent under pressure and that it is non-abrasive to tender skin. Other material candidates include polyurethane, neoprene, or the like. Polyurethane is soft like silicone, but it is not as non-reactive as silicone. Neoprene is very soft, so it might not work for the hardest desired devices and applications, but neoprene is resistant to oils. Those of skill in the art will appreciate that these and other suitable materials, whether synthetic or natural, are contemplated as being within the spirit and scope of the invention.

Those of skill in the art will appreciate that alternative embodiments are contemplated as being also within the spirit and scope of the invention. For example, device 10 within can be made of more than one material, e.g. a hard core region can be provided within a durable but deformable outer region. Or device 10 can be affixed at the end of a manipulable stick or handle, thereby to extend the user's reach and perhaps also to adjust the angle of impact of its working head on the subject's skin. All such suitable variations are contemplated as being within the spirit and scope of the invention.

Use of the Invention Device

Various grips can be used of the invented device to impart a penetrating massage without injury or repetitive motion injury to the user of the device. First is the plain overhand grip, which can be facilitated for professionals (e.g. LMTs, massage therapists, et al.) not interested in self-massage by the provision of a round base to fit the hand.

Another grip intended to help maintain a neutral wrist starts with the invented device, apex region down as shown in FIGS. 9A-9C, held between the index and middle finger of the non-dominant hand. The user makes a first with the dominant hand, places the knuckles on the base, and wraps the non-dominant hand over the first to secure the grip. In order to facilitate this grip, the invented device can be provided with a concave or flat base, as shown in FIG. 4.

Typically, the grip is as described above or using any suitable alternative. Next, the user places the tip or apex region of the device in contact with a subject at a desired massage site. Finally, the user applies pressure to the base of the device, which results in a greater pressure being delivered to the desired massage site via the tip. Those of skill in the art will appreciate that this pressure increase or multiplication (referred also to herein as power concentration) is a result of the leveraging action of the tapered region between the base and tip.

Use of the third embodiment of the invention shown in FIGS. 6, 7 and 8 by chiropractors is desirable as an adjusting and/or massaging tool. Stripping is a technique widely used to massage the muscles alongside the subject's spine, and the third embodiment described and illustrated herein is specially configured for such use whereby a user firmly grips the base of the device, optionally applies lotion to its working surfaces, and then moves the device with the spaced-apart apex regions spanning the spine up and down the spine of a subject. Those of skill in the art will appreciate that either side of the spine of a subject can be differentially stripped by angling the device slightly such that slightly differently positioned muscle regions of the spinae on either side of the spine are massaged at the same time, one muscle region being slightly higher on the spine than the other.

Self-massage is facilitated by the provision of a concave base, as illustrated by the dashed line of FIG. 4. Those of skill will appreciate that this embodiment of the invention can be affixed at a desired elevation on a shower wall, for example, and the subject/user can massage him or herself by moving gently or forcefully against the exposed working surface, e.g. the apex region, of the massage device, to similar effect as in the above use cases.

It will be appreciated that invented devices can be used to apply lateral pressure in addition to pressure incident at a generally right angle to the surface subject's body. Thus, while it is depicted schematically in FIGS. 9A-9C that pressure is downward or orthogonal to the subject's skin surface, it will be appreciated that the user can urge the device laterally as well such that the force vectors also have a lateral component. Such lateral pressure is often needed in producing something called cross-fiber friction against a muscle that desirably breaks up adhesion that occurs between adjacent, facia-bundled muscles. Such cross-fiber friction overcomes the adhesion and relaxes the muscle group. The use of invented device 10 also is helpful in reorienting muscle fibers and scar tissue in a linear direction.

During such maneuvers, more than the apex region may come into useful contact with the subject's skin. That is why reference is made herein to so-called working surface 18 that extends beyond the boundary of the apex region 16 and partway down and around upper region 14b.

Those of skill in the art will appreciate that the invented massage device is easy to use by professionals and non-professionals alike, whether to massage others or to self-massage. It is lightweight, yet it concentrates soft power into its working surface or head in the apex region of a cone-shaped device, the base of the device being gripped within the palm of the user's less dominant hand, and the other, more dominant hand typically being used atop the device-gripping hand to apply pressure and guidance. It can be used by any suitable technique to provide massage, adjustment, stripping, and/or other desirable manipulation. Its working surface or head can include one or more apex regions that are approximately the diameter of the human thumb and that deliver concentrated power to a trigger point or other target on the subject's joint, tendon, muscle, tissue, facie, and/or the like. The user nevertheless is able to deliver a desired depth and impact of the massage by haptic feedback provided by the unique configuration and material of the device.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. A massage device comprising:
a solid body including a base, an interior region and a working surface extending around the interior region from the base,
the base configured to fit in a user's palm and to be grasped by the user's hand,
the working surface including a contiguous convexly curved portion that tapers from the base toward an apex region of the working surface,
the interior region and the working surface being generally shape-retentive and deformable by a controlled amount when under compression when the device is in use,
the device configured to concentrate pressure impacting on the base and to deliver such concentrated pressure to the apex region of the working surface.

2. The device of claim 1, wherein the curved portion is generally cone-shaped.

3. The device of claim 2, wherein the apex region is rounded.

4. The device of claim 3, wherein the rounded apex region is configured to deform and flatten when the device is in use and the apex region is under compression.

5. The device of claim 3, wherein the apex region is configured to deform and flatten to a defined and controlled extent.

6. The device of claim 1, wherein the solid body has a cross-sectionally piece-wise linear contour between the base and the apex region.

7. The device of claim 1, wherein the working surface includes two or more such curved portions, each generally cone shaped and each terminating in an apex region.

8. The device of claim 6, wherein the two or more such curved portions are spaced apart from one another to a defined extent.

9. The device of claim 1, wherein the base is concave.

10. The device of claim 1, wherein the base is convex.

11. The device of claim 1 further comprising:
a strap or handle operatively coupled with the base.

12. The device of claim 1, wherein the solid body is integrally molded from one or more materials selected from the group including sililcone, polyurethane, and neoprene.

13. The device of claim 10, wherein the one or more materials is substantially non-abrasive to and substantially non-reactive with a subject's skin.

14. The device of claim 1, wherein the solid body has a Shore durometer rating of between approximately 30 and 40 on the A scale.

15. The device of claim 13, wherein the solid body has a Shore durometer rating of approximately 35 on the A scale.

16. The device of claim 1, wherein the solid body has a height to width ratio of between approximately 0.55 and 0.7.

17. The device of claim 16, wherein the solid body has a height to width ratio of approximately 0.65.

18. The device of claim 1, wherein the interior angle of the tapered region is between approximately 70° and 90°.

19. The device of claim 1, wherein the interior angle of the tapered region is approximately 80°.

20. A massage method comprising:
providing a hand-grippable device including a palm-sized base, a thumb-sized tip, and a tapered region therebetween;
gripping the base in the palm of a hand;
placing the tip of the device in contact with a subject at a desired massage site; and
applying a first pressure on the base by the hand thereby to apply a second pressure on the tip of the device in contact with the subject, the second pressure being greater than the first pressure by power concentration through the tapered region.

21. A massage device comprising:
a solid deformable but shape-retentive body including
a thumb-sized apex region;
a palm-sized base region; and
a tapered region therebetween configured to concentrate power applied at the base region into the apex region.
